(19) United States
(12) Patent Application Publication
(10) Pub. No.: US 2016/0024677 A1
(43) Pub. Date: Jan. 28, 2016

(54) MOLTEN-SALT ELECTROLYSIS PLATING APPARATUS AND METHOD FOR PRODUCING ALUMINUM FILM

(71) Applicant: SUMITOMO ELECTRIC INDUSTRIES, LTD., Osaka-shi, Osaka (JP)

(72) Inventors: Junichi NISHIMURA, Osaka-shi (JP); Akihisa HOSOE, Osaka-shi (JP); Kazuki OKUNO, Osaka-shi (JP); Koutarou KIMURA, Osaka-shi (JP); Kengo GOTO, Osaka-shi (JP); Hideaki SAKAIDA, Osaka-shi (JP)

(21) Appl. No.: 14/773,801

(22) PCT Filed: Jan. 20, 2014
(86) PCT No.: PCT/JP2014/050964

§ 371 Date: Sep. 9, 2015

(30) Foreign Application Priority Data
Mar. 12, 2013 (JP) 2013-049312
Mar. 12, 2013 (JP) 2013-049319
Mar. 12, 2013 (JP) 2013-049336
Mar. 12, 2013 (JP) 2013-049355

(51) Int. Cl. C25D 3/66; C08F 114/06; C08F 110/02; C25D 17/00

(52) U.S. Cl. CPC C25D 3/66; C25D 17/00; C08F 114/06; C08F 110/02

(57) ABSTRACT

A molten-salt electrolysis plating apparatus that uses a molten salt for a liquid electrolyte satisfies any one of (i) to (iv) below. (i) At least a portion that is in contact with the liquid electrolyte contains a vinyl chloride resin, and the vinyl chloride resin has a chlorine content of 51% by mass or more. (ii) At least a portion that is in contact with the liquid electrolyte contains a vinyl chloride resin, and the vinyl chloride resin contains titanium oxide. (iii) At least a portion that is in contact with the liquid electrolyte contains a polyethylene resin, and the polyethylene resin has a density of 0.940 g/cm³ or more. (iv) At least a portion that is in contact with the liquid electrolyte contains a polyethylene resin, and the polyethylene resin has a tensile strength of 15 MPa or more.

### TECHNICAL FIELD

The present invention relates to a molten-salt electrolysis plating apparatus and a method for producing an aluminum film, the method including electroplating a surface of a base with aluminum using the molten-salt electrolysis plating apparatus.

### BACKGROUND ART

Aluminum is passivated as a result of formation of a dense oxide film on a surface thereof, and exhibits good corrosion resistance. Therefore, a surface of a steel strip or the like is plated with aluminum to enhance corrosion resistance. In the case where a surface of a base is plated with aluminum, it is difficult to perform electroplating in an aqueous solution-based plating bath because aluminum has high affinity to oxygen and the electric potential of aluminum is lower than that of hydrogen. Therefore, a molten-salt bath is used.

As in the case of electrolysis plating with aluminum, a plating liquid used in performing molten-salt electrolysis plating contains a chloride salt and has very high corrosiveness, and furthermore, the operating temperature is usually high, namely, 200° C. or more. Therefore, in a plating apparatus, it is necessary to use a material having heat resistance and corrosion resistance in a liquid-contact portion that is in contact with a plating liquid. In addition, in order to prevent an applied current from straying, the material needs to further have an insulating property.

Examples of an inorganic material used as such a material include ceramics and glass. Examples of an organic material used as such a material include fluororesins (such as polytetrafluoroethylene (PTFE) and polytetrafluoroethylene-perfluoroalkyl vinyl ether copolymers (PFA)) and super engineering plastics (such as polyether ether ketone (PEEK) and polyphenylene sulfide (PPS)), but these organic materials are limited.

For example, the literatures below describe the use of the above resin materials in a plating apparatus.

Japanese Unexamined Patent Application Publication No. 01-312098 (PTL 1) describes that a polyimide resin is used in a liquid-contact portion of a molten-salt electrolysis plating apparatus that uses a molten-salt bath containing aluminum chloride as a chloride, the liquid-contact portion being in contact with a plating liquid. Japanese Unexamined Patent Application Publication No. 06-010195 (PTL 2) describes that an inorganic material or an organic resin respectively having an insulation resistance of 1MΩ or more is used in an insulating portion in a plating tank of a molten-salt electrolysis plating apparatus. PTL 2 describes a polyether ether ketone resin and a polyphenylene sulfide resin as examples of the organic resin.

The inorganic materials such as ceramics and glass crack and break easily, and have very poor machinability. Accordingly, there may be a problem in using these inorganic materials in a plating apparatus in that a high machining cost is necessary. Furthermore, there may be a problem in using the particular organic materials in that the materials are very expensive.

### CITATION LIST

### Patent Literature

PTL 1: Japanese Unexamined Patent Application Publication No. 01-312098
PTL 2: Japanese Unexamined Patent Application Publication No. 06-010195

### SUMMARY OF INVENTION

### Technical Problem

In view of the above problems, an object of the present invention is to provide a molten-salt electrolysis plating apparatus at a low cost, the plating apparatus being capable of stably conducting molten-salt electrolysis plating for a long period of time.

### Solution to Problem

The inventors of the present invention conducted intensive studies in order to solve the above problems, and examined the use of a low-cost organic material having good machinability in a contact portion of a molten-salt electrolysis plating apparatus, the contact portion being in contact with a liquid electrolyte.

Examples of the low-cost organic material having good machinability include vinyl chloride resins. Although vinyl chloride resins are inexpensive and general-purpose resins, in general, vinyl chloride resins are believed to have a problem in terms of heat resistance and corrosion resistance. For example, PTL 1 describes that a rubber lining material, vinyl chloride, and Bakelite, all of which are used in an aqueous solution-based plating bath, cannot be used in the case of a molten salt because the operating temperature usually exceeds 200° C. Thus, with the exception of an example of a vinyl chloride resin used in a plating apparatus that is operated at room temperature (for example, Japanese Unexamined Utility Model Registration Application Publication No. 53-005313), there are no known examples of a vinyl chloride resin used in a molten-salt electrolysis plating apparatus that uses a molten-salt bath.

Accordingly, as a result of further intensive studies, the inventors of the present invention found that it is effective to adopt the following. At least a portion of a molten-salt electrolysis plating apparatus, the portion being in contact with a liquid electrolyte, contains a vinyl chloride resin, and the vinyl chloride resin has a chlorine content of 51% by mass or more.

In addition, as a result of further intensive studies, the inventors of the present invention found that it is effective to adopt the following. At least a portion of a molten-salt electrolysis plating apparatus, the portion being in contact with a liquid electrolyte, contains a vinyl chloride resin, and the vinyl chloride resin contains titanium oxide. Furthermore, as a result of further intensive studies, the inventors of the present invention found that it is effective to adopt the following. At least a portion of a molten-salt electrolysis plating apparatus, the portion being in contact with a liquid electrolyte, contains a polyethylene resin, and the polyethylene resin has a density of 0.940 g/cm³ or more.
Furthermore, as a result of further intensive studies, the inventors of the present invention found that it is effective to adopt the following. At least a portion of a molten-salt electrolysis plating apparatus, the portion being in contact with a liquid electrolyte, contains a polyethylene resin, and the polyethylene resin has a tensile strength of 15 MPa or more.
Thus, the inventors of the present invention have found the effectiveness and completed the present invention. The molten-salt electrolysis plating apparatus of the present invention has the configurations described below.
A molten-salt electrolysis plating apparatus that uses a molten salt for a liquid electrolyte, the molten-salt electrolysis plating apparatus satisfying any one of (i) to (iv) below.
(i) At least a portion of the molten-salt electrolysis plating apparatus, the portion being in contact with the liquid electrolyte, contains a vinyl chloride resin, and the vinyl chloride resin has a chlorine content of 51° A by mass or more.
(ii) A molten-salt electrolysis plating apparatus that uses a molten salt for a liquid electrolyte, in which at least a portion of the molten-salt electrolysis plating apparatus, the portion being in contact with the liquid electrolyte, contains a vinyl chloride resin, and the vinyl chloride resin contains titanium oxide.
(iii) A molten-salt electrolysis plating apparatus that uses a molten salt for a liquid electrolyte, in which at least a portion of the molten-salt electrolysis plating apparatus, the portion being in contact with the liquid electrolyte, contains a polyethylene resin, and the polyethylene resin has a density of 0.940 g/cm³ or more.
(iv) A molten-salt electrolysis plating apparatus that uses a molten salt for a liquid electrolyte, in which at least a portion of the molten-salt electrolysis plating apparatus, the portion being in contact with the liquid electrolyte, contains a polyethylene resin, and the polyethylene resin has a tensile strength of 15 MPa or more.

According to the molten-salt electrolysis plating apparatus which is any of (i) to (iv) above, since the portion that is in contact with the liquid electrolyte has good heat resistance and good corrosion resistance, molten-salt electrolysis plating can be stably performed for a long period of time. In addition, vinyl chloride resins and polyethylene resins are cheaper than fluororesins and super engineering plastics. Therefore, the molten-salt electrolysis plating apparatus using a vinyl chloride resin or a polyethylene resin can be provided at a very low cost compared with existing apparatuses.

(2) The molten-salt electrolysis plating apparatus according to (1) above, in which at least a portion of the molten-salt electrolysis plating apparatus, the portion being in contact with the liquid electrolyte, contains a vinyl chloride resin, the vinyl chloride resin has a chlorine content of 51% by mass or more, and the vinyl chloride resin has a number-average molecular weight of 50,000 or more and 100,000 or less.

According to the molten-salt electrolysis plating apparatus according to (2) above, since the vinyl chloride resin has a high degree of polymerization, heat resistance and corrosion resistance of a portion of the molten-salt electrolysis plating apparatus, the portion being in contact with a liquid electrolyte, can be enhanced.

(3) The molten-salt electrolysis plating apparatus according to (1) or (2) above, in which at least a portion of the molten-salt electrolysis plating apparatus, the portion being in contact with the liquid electrolyte, contains a vinyl chloride resin, the vinyl chloride resin has a chlorine content of 51% by mass or more, and the vinyl chloride resin contains a stabilizing agent that contains lead.

According to the molten-salt electrolysis plating apparatus according to (3) above, since the vinyl chloride resin contains a stabilizing agent that contains lead, heat resistance and corrosion resistance of a portion of the molten-salt electrolysis plating apparatus, the portion being in contact with a liquid electrolyte, can be further enhanced.

(4) The molten-salt electrolysis plating apparatus according to (1) above, in which at least a portion of the molten-salt electrolysis plating apparatus, the portion being in contact with the liquid electrolyte, contains a vinyl chloride resin, the vinyl chloride resin contains titanium oxide, and the vinyl chloride resin has a titanium oxide content of 0.1% by mass or more and 15% by mass or less.

Since the content of titanium oxide in the vinyl chloride resin is in the above range, sufficient effects of heat resistance and corrosion resistance are obtained without impairing formability of the resin.

(5) The molten-salt electrolysis plating apparatus according to (1) or (4) above, in which at least a portion of the molten-salt electrolysis plating apparatus, the portion being in contact with the liquid electrolyte, contains a vinyl chloride resin, the vinyl chloride resin contains titanium oxide, and the titanium oxide has a particle diameter of 0.1 μm or more and 100 μm or less.

By adding titanium oxide having a particle diameter in the above range to a vinyl chloride resin, a vinyl chloride resin having good formability and good heat resistance and corrosion resistance can be obtained.

(6) The molten-salt electrolysis plating apparatus according to (1) above, in which at least a portion of the molten-salt electrolysis plating apparatus, the portion being in contact with the liquid electrolyte, contains a polyethylene resin, the polyethylene resin has a density of 0.940 g/cm³ or more, and the polyethylene resin has a weight-average molecular weight of 500,000 or more and 6,500,000 or less.

According to the molten-salt electrolysis plating apparatus according to (6) above, since the polyethylene resin has a high degree of polymerization, heat resistance and corrosion resistance of a portion of the molten-salt electrolysis plating apparatus, the portion being in contact with a liquid electrolyte, can be enhanced.

(7) The molten-salt electrolysis plating apparatus according to (1) or (6) above, in which at least a portion of the molten-salt electrolysis plating apparatus, the portion being in contact with the liquid electrolyte, contains a polyethylene resin, the polyethylene resin has a density of 0.940 g/cm³ or more, and the polyethylene resin contains titanium oxide.

By incorporating titanium oxide as a filler in the polyethylene resin, a resin having further improved heat resistance and corrosion resistance can be obtained.

(8) The molten-salt electrolysis plating apparatus according to (1) above, in which at least a portion of the molten-salt electrolysis plating apparatus, the portion being in contact with the liquid electrolyte, contains a polyethylene resin, the polyethylene resin has a tensile strength of 15 MPa or more, and the polyethylene resin has a weight-average molecular weight of 500,000 or more and 6,500,000 or less.

According to the molten-salt electrolysis plating apparatus according to (8) above, since the polyethylene resin has a high degree of polymerization, heat resistance and corrosion resistance of a portion of the molten-salt electrolysis plating apparatus, the portion being in contact with a liquid electrolyte, can be enhanced.

(9) The molten-salt electrolysis plating apparatus according to (1) or (8) above, in which at least a portion of the molten-salt electrolysis plating apparatus, the portion being in contact with the liquid electrolyte, contains a polyethylene resin, the polyethylene resin has a tensile strength of 15 MPa or more, and the polyethylene resin has a degree of crystallinity of 50% or more and 80% or less.

According to the molten-salt electrolysis plating apparatus according to (9) above, since the polyethylene resin has a high degree of crystallinity, heat resistance and corrosion resistance of a portion of the molten-salt electrolysis plating apparatus, the portion being in contact with a liquid electrolyte, can be enhanced.

In the present invention, the term “degree of crystallinity” refers to a value measured by differential scanning calorimetry (DSC).

(10) The molten-salt electrolysis plating apparatus according to any one of (1) to (9) above, in which the molten salt contains aluminum chloride and has a melting point of 80° C. or less.

The molten-salt electrolysis plating apparatus according to (10) above has heat resistance and corrosion resistance for a long period of time even against a liquid electrolyte containing aluminum chloride and having high corrosiveness, and thus can stably form an aluminum film on a surface of a base.

(11) A method for producing an aluminum film, the method including electrodepositing aluminum on a base by using the molten-salt electrolysis plating apparatus according to any one of (1) to (10) above.

The method for producing an aluminum film according to (11) above uses a molten-salt electrolysis plating apparatus in which a portion of the apparatus, the portion being in contact with a liquid electrolyte, is composed of a vinyl chloride resin and which is cheaper than existing apparatuses. Accordingly, an aluminum film can be produced on a surface of a base at a low cost.

### Advantageous Effects of Invention

According to the present invention, it is possible to provide a molten-salt electrolysis plating apparatus at a low cost, the plating apparatus being capable of stably conducting molten-salt electrolysis plating for a long period of time.

### DESCRIPTION OF EMBODIMENTS

A molten-salt electrolysis plating apparatus according to the present invention is a molten-salt electrolysis plating apparatus that uses a molten salt for a liquid electrolyte, in which the molten-salt electrolysis plating apparatus satisfies any one of (i) to (iv) below.

(i) At least a portion of the molten-salt electrolysis plating apparatus, the portion being in contact with the liquid electrolyte, contains a vinyl chloride resin, and the vinyl chloride resin has a chlorine content of 51% by mass or more.

(ii) At least a portion of the molten-salt electrolysis plating apparatus, the portion being in contact with the liquid electrolyte, contains a vinyl chloride resin, and the vinyl chloride resin contains titanium oxide.

(iii) At least a portion of the molten-salt electrolysis plating apparatus, the portion being in contact with the liquid electrolyte, contains a polyethylene resin, and the polyethylene resin has a density of 0.940 g/cm³ or more.

(iv) At least a portion of the molten-salt electrolysis plating apparatus, the portion being in contact with the liquid electrolyte, contains a polyethylene resin, and the polyethylene resin has a tensile strength of 15 MPa or more.

(i) In a molten-salt electrolysis plating apparatus, since a liquid electrolyte (plating liquid) containing a chloride salt and having high corrosiveness is used, it is necessary for a portion that is in contact with the plating liquid to have corrosion resistance. In the present invention, at least a portion that is in contact with a liquid electrolyte may be composed of a vinyl chloride resin having a chlorine content of 51% by mass or more. As described below, the vinyl chloride resin may contain additives within a range that does not impair the functions of corrosion resistance and heat resistance.

In the molten-salt electrolysis plating apparatus of the present invention, regarding a component including the portion that is in contact with the liquid electrolyte, the whole component is not particularly necessarily composed of the vinyl chloride resin, and it is sufficient that at least the portion that is in contact with the liquid electrolyte be composed of the vinyl chloride resin. The whole component may be composed of the vinyl chloride resin depending on the structure.

Examples of the component that is in contact with the liquid electrolyte in the molten-salt electrolysis plating apparatus include, but are not limited to, a plating tank to be filled with a liquid electrolyte, a partition plate that is provided in a plating tank as required, piping for circulating a liquid electrolyte, a roller for conveying a workpiece in a liquid electrolyte, and an anode case. Specifically, in accordance with the structure of the molten-salt electrolysis plating apparatus, a portion of a component that may be in contact with a liquid electrolyte, the portion having a possibility of being in contact with the liquid electrolyte, is covered with the vinyl chloride resin. In the molten-salt electrolysis plating apparatus of the present invention, there is no particular problem when a portion that is not in contact with a liquid electrolyte is composed of the vinyl chloride resin.

The vinyl chloride resin has a chlorine content of 51% by mass or more. A chlorine content of less than 51% by mass is not preferable because the effects of heat resistance and corrosion resistance are not sufficiently achieved.

The chlorine content of the vinyl chloride resin is more preferably 54% by mass or more, and still more preferably 60% by mass or more.

When the chlorine content exceeds 70% by mass, fluidity significantly decreases, and it becomes difficult to form the vinyl chloride resin. Therefore, the chlorine content of the vinyl chloride resin is preferably 70% by mass or less.

Typical vinyl chloride resins contain plasticizing agents. However, in the present invention, a vinyl chloride resin having a low content of a plasticizing agent is preferably used. This is because there may be a problem in that the plasticizing agent elutes in a plating liquid under the conditions in which plating is performed using the molten-salt electrolysis plating apparatus of the present invention. If a plasticizing agent elutes in a plating liquid, a problem in terms of corrosion resistance occurs, for example, cracking or breaking of the vinyl chloride resin starts to occur. Furthermore, mixing of a plasticizing agent in a plating liquid may result in degradation of the plating liquid.

Therefore, the content of a plasticizing agent is preferably very small. Preferably, a plasticizing agent is not contained if at all possible. Specifically, the content of a plasticizing agent in the vinyl chloride resin is preferably 5% by mass or less.

As described above, a portion that is in contact with a liquid electrolyte in the molten-salt electrolysis plating apparatus is composed of a vinyl chloride resin having a chlorine content of 51% by mass or more and a low content of a plasticizing agent. Accordingly, the molten-salt electrolysis plating apparatus can have good heat resistance and good corrosion resistance.

The vinyl chloride resin preferably has a number-average molecular weight (Mn) of 50,000 or more and 100,000 or less. When the vinyl chloride resin has a high degree of polymerization and has a high molecular weight, the resin is dense and can prevent a plating liquid (liquid electrolyte) from permeating therethrough. This is preferable because the resin has higher heat resistance and higher corrosion resistance. The number-average molecular weight of the vinyl chloride resin is more preferably 55,000 or more and 95,000 or less, and still more preferably 60,000 or more and 90,000 or less.

The vinyl chloride resin preferably contains a stabilizing agent. Since a stabilizing agent used in a vinyl chloride resin usually suppresses elimination of HCl by heat, the vinyl chloride resin can have higher heat resistance.

The stabilizing agent is not particularly limited and publicly known stabilizing agents can be used, as required. However, a stabilizing agent that contains lead is more preferable. By incorporating a stabilizing agent that contains lead, a resin having not only higher heat resistance but also higher corrosion resistance can be obtained. Examples of the stabilizing agent that contains lead include tribasic lead sulfate, dibasic lead sulfite, and dibasic lead phosphite.

The content of the stabilizing agent in the vinyl chloride resin is preferably 1% by mass or more and 8% by mass or less.

(ii) In a molten-salt electrolysis plating apparatus, since a liquid electrolyte (plating liquid) containing a chloride salt and having high corrosiveness is used, it is necessary for a portion that is in contact with the plating liquid to have corrosion resistance. In the present invention, at least a portion that is in contact with a liquid electrolyte may be composed of a vinyl chloride resin that contains titanium oxide. As described below, the vinyl chloride resin may contain additives within a range that does not impair the functions of corrosion resistance and heat resistance.

In the molten-salt electrolysis plating apparatus of the present invention, regarding a component including the portion that is in contact with the liquid electrolyte, the whole component is not particularly necessarily composed of the vinyl chloride resin, and it is sufficient that at least the portion that is in contact with the liquid electrolyte be composed of the vinyl chloride resin. The whole component may be composed of the vinyl chloride resin depending on the structure.

Examples of the component that is in contact with the liquid electrolyte in the molten-salt electrolysis plating apparatus include, but are not limited to, a plating tank to be filled with a liquid electrolyte, a partition plate that is provided in a plating tank as required, piping for circulating a liquid electrolyte, a roller for conveying a workpiece in a liquid electrolyte, and an anode case. Specifically, in accordance with the structure of the molten-salt electrolysis plating apparatus, a portion of a component that may be in contact with a liquid electrolyte, the portion having a possibility of being in contact with the liquid electrolyte, is covered with the vinyl chloride resin. In the molten-salt electrolysis plating apparatus of the present invention, there is no particular problem when a portion that is not in contact with a liquid electrolyte is composed of the vinyl chloride resin.

As described above, the vinyl chloride resin in the present invention contains titanium oxide. Accordingly, heat resistance and corrosion resistance improve. Even when the vinyl chloride resin is in contact with a liquid electrolyte containing a chloride salt such as aluminum chloride, the vinyl chloride resin does not corrode.

The content of titanium oxide in the vinyl chloride resin is preferably 0.1% by mass or more and 15% by mass or less. When the content of titanium oxide is 0.1% by mass or more, the effect of improving heat resistance and corrosion resistance of the vinyl chloride resin is sufficiently achieved. When the content of titanium oxide is 15% by mass or less, the effects of heat resistance and corrosion resistance are obtained without impairing formability of the resin.

The content of titanium oxide in the vinyl resin is more preferably 0.5% by mass or more and 10% by mass or less, and still more preferably 1% by mass or more and 5% by mass or less.

The type of titanium oxide is not particularly limited, and any of anatase (octahedrite), rutile, and brookite (pyromelane) may be used. These may be used as a mixture.

The particle diameter of the titanium oxide is not particularly limited. However, titanium oxide having a particle diameter of 0.1 μm or more and 100 μm or less is preferably used. When the particle diameter of the titanium oxide contained in the vinyl resin is 0.1 μm or more, the effect of improving heat resistance and corrosion resistance of the resin is sufficiently achieved. When the particle diameter of the titanium oxide is 100 μm or less, the effect of improving heat resistance and corrosion resistance is obtained without impairing formability of the resin.

The particle diameter of the titanium oxide is more preferably 0.2 μm or more and 20 μm or less, and still more preferably 0.5 μm or more and 5 μm or less.

The vinyl chloride resin in the present invention preferably has a chlorine content of 51% by mass or more. A chlorine content of 51% by mass or more is preferable because the effects of heat resistance and corrosion resistance are sufficiently achieved. The chlorine content of the vinyl chloride resin is more preferably 54% by mass or more, and still more preferably 60% by mass or more.

When the chlorine content exceeds 70% by mass, fluidity significantly decreases, and it becomes difficult to form the vinyl chloride resin. Therefore, the chlorine content of the vinyl chloride resin is preferably 70% by mass or less.

Typical vinyl chloride resins contain plasticizing agents. However, in the present invention, a vinyl chloride resin having a low content of a plasticizing agent is preferably used. This is because the plasticizing agent may elute in a plating liquid under the conditions in which plating is performed using the molten-salt electrolysis plating apparatus of the present invention. If a plasticizing agent elutes in a plating liquid, a problem in terms of corrosion resistance occurs, for example, cracking or breaking of the vinyl chloride resin starts to occur. Furthermore, mixing of a plasticizing agent in a plating liquid may result in degradation of the plating liquid.

Therefore, the content of a plasticizing agent is preferably very small. More preferably, a plasticizing agent is not contained. Specifically, the content of a plasticizing agent in the vinyl chloride resin is preferably 5% by mass or less.

The vinyl chloride resin preferably has a number-average molecular weight (Mn) of 50,000 or more and 100,000 or less. When the vinyl chloride resin has a high degree of polymerization and has a high molecular weight, the resin is dense and can prevent a plating liquid (liquid electrolyte) from permeating therethrough. This is preferable because the resin has higher heat resistance and higher corrosion resistance. The number-average molecular weight of the vinyl chloride resin is more preferably 55,000 or more and 95,000 or less, and still more preferably 60,000 or more and 90,000 or less.

The vinyl chloride resin preferably contains a stabilizing agent. Since a stabilizing agent used in a vinyl chloride resin usually suppresses elimination of MCI by heat, the vinyl chloride resin can have higher heat resistance.

The stabilizing agent is not particularly limited and publicly known stabilizing agents can be used, as required. However, a stabilizing agent that contains lead is more preferable. By incorporating a stabilizing agent that contains lead, a resin having not only higher heat resistance but also higher corrosion resistance can be obtained. Examples of the stabilizing agent that contains lead include tribasic lead sulfate, dibasic lead sulfite, and dibasic lead phosphite.

The content of the stabilizing agent in the vinyl chloride resin is preferably 1% by mass or more and 8% by mass or less.

(iii) In a molten-salt electrolysis plating apparatus, since a liquid electrolyte (plating liquid) containing a chloride salt and having high corrosiveness is used, it is necessary for a portion that is in contact with the plating liquid to have corrosion resistance. In the present invention, at least a portion that is in contact with a liquid electrolyte may be composed of a polyethylene resin having a density of 0.940 g/cm³ or more.

The polyethylene resin may contain additives within a range that does not impair the functions of corrosion resistance and heat resistance. Examples of the additives include calcium carbonate, hydrous magnesium silicate (talc), kaolin clay, barium sulfate, and zeolite.

In the molten-salt electrolysis plating apparatus of the present invention, regarding a component including the portion that is in contact with the liquid electrolyte, the whole component is not particularly necessarily composed of the polyethylene resin, and it is sufficient that at least the portion that is in contact with the liquid electrolyte be composed of the polyethylene resin. The whole component may be composed of the polyethylene resin depending on the structure.

Examples of the component that is in contact with the liquid electrolyte in the molten-salt electrolysis plating apparatus include, but are not limited to, a plating tank to be filled with a liquid electrolyte, a partition plate that is provided in a plating tank as required, piping for circulating a liquid electrolyte, a roller for conveying a workpiece in a liquid electrolyte, and an anode case. Specifically, in accordance with the structure of the molten-salt electrolysis plating apparatus, a portion of a component that may be in contact with a liquid electrolyte, the portion having a possibility of being in contact with the liquid electrolyte, is covered with the polyethylene resin. In the molten-salt electrolysis plating apparatus of the present invention, there is no particular problem when a portion that is not in contact with a liquid electrolyte is composed of the polyethylene resin.

The polyethylene resin is a so-called high-density polyethylene resin having a density of 0.940 g/cm³ or more. A density of the polyethylene resin of less than 0.940 g/cm³ is not preferable because the effects of heat resistance and corrosion resistance are not sufficiently achieved. The density of the polyethylene resin is more preferably 0.945 g/cm³ or more, and still more preferably 0.950 g/cm³ or more.

When the density of the polyethylene resin exceeds 0.970 g/cm³, the resin becomes brittle. Accordingly, the density is preferably 0.970 g/cm³ or less. The density of the polyethylene resin is more preferably 0.965 g/cm³ or less, and still more preferably 0.960 g/cm³ or less.

The polyethylene resin preferably has a weight-average molecular weight (Mw) of 500,000 or more and 6,500,000 or less. When the polyethylene resin has a high degree of polymerization and has a high molecular weight, the resin is dense and can prevent a plating liquid (liquid electrolyte) from permeating therethrough. This is preferable because the resin has higher heat resistance and higher corrosion resistance. The weight-average molecular weight of the polyethylene resin is more preferably 800,000 or more and 4,000,000 or less, and still more preferably 1,000,000 or more and 3,000,000 or less.

The polyethylene resin preferably contains titanium oxide as a filler. In this case, heat resistance and corrosion resistance of the polyethylene resin can be further improved.

The type of crystal structure of titanium oxide contained in the polyethylene resin is not particularly limited, and any of anatase (octahedrite), rutile, and brookite (pyromelane) may be used. These may be used as a mixture.

The content of titanium oxide in the polyethylene resin is preferably 0.1% by mass or more and 15% by mass or less. When the content of titanium oxide is 0.1% by mass or more, heat resistance and corrosion resistance of the polyethylene resin can be further improved. When the content of titanium oxide is 15% by mass or less, the effects of heat resistance and corrosion resistance are obtained without impairing formability of the resin.

The content of titanium oxide in the polyethylene resin is more preferably 0.5% by mass or more and 10% by mass or less, and still more preferably 1% by mass or more and 5% by mass or less.

The particle diameter of the titanium oxide is not particularly limited. However, titanium oxide having a particle diameter of 0.1 μm or more and 100 μm or less is preferably used. When the particle diameter of the titanium oxide contained in the polyethylene resin is 0.1 μm or more, the effect of improving heat resistance and corrosion resistance of the resin is sufficiently achieved. When the particle diameter of the titanium oxide is 100 μm or less, the effect of improving heat resistance and corrosion resistance is obtained without impairing formability of the resin.

The particle diameter of the titanium oxide is more preferably 0.2 μm or more and 20 μm or less, and still more preferably 0.5 uun or more and 5 μm or less.

(iv) In a molten-salt electrolysis plating apparatus, since a liquid electrolyte (plating liquid) containing a chloride salt and having high corrosiveness is used, it is necessary for a portion that is in contact with the plating liquid to have corrosion resistance. In the present invention, at least a portion that is in contact with a liquid electrolyte may be composed of a polyethylene resin having a tensile strength of 15 MPa or more.

The polyethylene resin may contain additives within a range that does not impair the functions of corrosion resistance and heat resistance. Examples of the additives include calcium carbonate, hydrous magnesium silicate (talc), kaolin clay, barium sulfate, and zeolite.

In the molten-salt electrolysis plating apparatus of the present invention, regarding a component including the portion that is in contact with the liquid electrolyte, the whole component is not particularly necessarily composed of the polyethylene resin, and it is sufficient that at least the portion that is in contact with the liquid electrolyte be composed of the polyethylene resin. The whole component may be composed of the polyethylene resin depending on the structure.

Examples of the component that is in contact with the liquid electrolyte in the molten-salt electrolysis plating apparatus include, but are not limited to, a plating tank to be filled with a liquid electrolyte, a partition plate that is provided in a plating tank as required, piping for circulating a liquid electrolyte, a roller for conveying a workpiece in a liquid electrolyte, and an anode case. Specifically, in accordance with the structure of the molten-salt electrolysis plating apparatus, a portion of a component that may be in contact with a liquid electrolyte, the portion having a possibility of being in contact with the liquid electrolyte, is covered with the polyethylene resin. In the molten-salt electrolysis plating apparatus of the present invention, there is no particular problem when a portion that is not in contact with a liquid electrolyte is composed of the polyethylene resin.

The polyethylene resin has a tensile strength of 15 MPa or more. A tensile strength of the polyethylene resin of less than 15 MPa is not preferable because the effects of heat resistance and corrosion resistance are not sufficiently achieved. The tensile strength of the polyethylene resin is more preferably 18 MPa or more, and still more preferably 20 MPa or more.

When the tensile strength exceeds 30 MPa, the polyethylene resin becomes brittle. Accordingly, the tensile strength is preferably 30 MPa or less. The tensile strength of the polyethylene resin is more preferably 28 MPa or less, and still more preferably 25 MPa or less.

The polyethylene resin preferably has a weight-average molecular weight (Mw) of 500,000 or more and 6,500,000 or less. When the polyethylene resin has a high degree of polymerization and has a high molecular weight, the resin is dense and can prevent a plating liquid (liquid electrolyte) from permeating therethrough. This is preferable because the resin has higher heat resistance and higher corrosion resistance. The weight-average molecular weight of the polyethylene resin is more preferably 800,000 or more and 4,000,000 or less, and still more preferably 1,000,000 or more and 3,000,000 or less.

The polyethylene resin preferably has a degree of crystallinity of 50% or more and 80% or less. When the polyethylene resin has a degree of crystallinity of 50% or more, the resin has higher heat resistance and higher corrosion resistance. By using such a resin in a portion that is in contact with a liquid electrolyte in a molten-salt electrolysis plating apparatus, a molten-salt electrolysis plating apparatus that can be stably used for a long period of time can be provided at a low cost. When the degree of crystallinity of the polyethylene resin exceeds 80%, the resin becomes excessively hard and brittle. Therefore, the degree of crystallinity of the polyethylene resin is preferably 80% or less.

From the above viewpoint, the degree of crystallinity of the polyethylene resin is more preferably 55% or more and 75% or less, and still more preferably 60% or more and 70% or less.

Preferably, the molten salt contains aluminum chloride and has a melting point of 80° C. or less. In this case, an aluminum film can be continuously stably formed on a surface of a base by using the molten-salt electrolysis plating apparatus of the present invention.

For example, an organic molten salt which is a eutectic salt of an organic halide and a chloride of aluminum can be used as the molten salt. Such an organic molten salt changes to a liquid state at 80° C. or less, and can be preferably used in the molten-salt electrolysis plating apparatus of the present invention.

As the organic halide, an imidazolium salt and/or a pyridinium salt can be preferably used. The molten salt preferably contains any of these and aluminum chloride. The imidazolium salt is preferably an alkyl imidazolium chloride, and the pyridinium salt is preferably an alkyl pyridinium chloride. In this case, the alkyl groups of the alkyl imidazolium chloride and the alkyl pyridinium chloride preferably have 1 to 5 carbon atoms.

Among the above molten salts, a liquid electrolyte formed by a mixture of aluminum chloride and 1-ethyl-3-methylimidazolium chloride (EMIC) and a liquid electrolyte formed by a mixture of aluminum chloride and butylpyridinium chloride (BPC) are more preferable. The liquid electrolyte is heated to 40° C. to 60° C. and used as a plating liquid of aluminum.

Each of the liquid electrolytes may contain additives in addition to the molten salts.

As described above, according to the molten-salt electrolysis plating apparatus of the present invention, a portion that is in contact with a liquid electrolyte is composed of an inexpensive vinyl chloride resin or polyethylene resin. Accordingly, with an increase in the area of a component including a portion that is in contact with a liquid electrolyte, the molten-salt electrolysis plating apparatus of the present invention can be provided at a lower cost. An example of a component having a large area that is in contact with a liquid electrolyte is a plating tank to be filled with a liquid electrolyte (plating liquid). For example, in the case where a plating film is formed on a surface of a long, sheet-like base, a relatively long plating tank is used accordingly. In such a case, the cost of the production of a molten-salt electrolysis plating apparatus can be significantly reduced. In addition, since the vinyl chloride resin has high heat resistance and high corrosion resistance for a long period of time, the molten-salt electrolysis plating apparatus of the present invention can be stably used for a long period of time. Furthermore, by using this molten-salt electrolysis plating apparatus, a plating film such as an aluminum film can be stably provided, and the cost of a product can be significantly reduced.

Regarding the molten-salt electrolysis plating apparatus according to the present invention, it is sufficient that at least a portion that is in contact with a liquid electrolyte be composed of the vinyl chloride resin or the polyethylene resin, and other structures may be the same as those of an existing molten-salt electrolysis plating apparatus.

Examples of the base include, but are not particularly limited to, steel strips and resin formed bodies which have a three-dimensional network structure and which have been subjected to a conductivity-imparting treatment.

In a method for producing an aluminum film according to the present invention, an aluminum film is electrodeposited on a base by using the molten-salt electrolysis plating apparatus of the present invention. The molten salts described above can be preferably used. In such a case, an aluminum film can be stably produced at an operating temperature of 40° C. to 60° C. Furthermore, an aluminum film can also be formed on a surface of a long, sheet-like base, as described above, by a plating method at a low cost. Thus, the cost of a product can be significantly reduced.

### EXAMPLES

The present invention will now be described in more detail on the basis of Examples. These Examples are only illustrative, and the molten-salt electrolysis plating apparatus of the present invention, etc. are not limited thereto. The scope of the present invention is defined by the claims described below, and includes equivalents of the claims and all modifications within the scope of the claims.

First, a description will be made of a method for evaluating corrosion resistance of a vinyl chloride resin used in a molten-salt electrolysis plating apparatus of the present invention.

### —Method for Evaluating Corrosion Resistance and Heat Resistance of Vinyl Chloride Resin—

(1) A test piece composed of a vinyl chloride resin and having a rectangular columnar shape (5×5×10 mm) is prepared.
(2) The test piece is immersed in 5 mL of a liquid electrolyte (plating liquid), and stored in a thermostatic chamber at 80° C.
(3) The state of the test piece is periodically checked.
(4) After three months at the longest, the test piece is taken out, and a surface and a cross section of the test piece are observed.

### <Evaluation Criteria>

In the observation of the surface and the cross section of the test piece in (4) above, only in the case where both the surface and the cross section did not degrade compared with those before the immersion, it was determined that the test piece had corrosion resistance and heat resistance. In the case where degradation such as a trace of corrosion or a crack was observed, it was determined that the test piece did not have corrosion resistance.

A test piece having low corrosion resistance eluted in the liquid electrolyte at the time of (3) above. A test piece having an extremely low corrosion resistance dissolved in the liquid electrolyte completely. With regard to a test piece having somewhat low corrosion resistance, the liquid color of the liquid electrolyte changed from transparent to black due to an eluted component of the resin.

### Example 1 and Comparative Example

As shown in Table I, vinyl chloride resins having the respective compositions were prepared, and processed to have a rectangular columnar shape, as described above. Thus, test pieces 1 to 6 were prepared. A liquid in which 1-ethyl-3-methylimidazolium chloride and aluminum chloride were mixed in a molar ratio of 1:2 was prepared as a liquid electrolyte.

As in the method for evaluating corrosion resistance described above, each of the test pieces was immersed in 5 mL of the liquid electrolyte and stored in a thermostatic chamber at 80° C.

Table I shows the results.

TABLE I

| | | | Number- | | | | | |
|---|---|---|---|---|---|---|---|---|
| | | | average | | | | | Evaluation |
| | | Chlorine | molecular | Stabilizing agent | | Plasticizing agent | | Heat resistance/ |
| | | content | weight | | Content | | Content | Corrosion |
| | | (mass %) | (Mn) | Type | (mass %) | Type | (mass %) | resistance |
| Example | Test piece 1 | 61 | 56,000 | Calcium salt of fatty | 5 | Phthalic | 4 | Have |
| | | | | acid/Zinc salt of | | acid ester | | |
| | | | | fatty acid | | | | |
| | Test piece 2 | 54 | 64,000 | Calcium salt of fatty | 5 | Phthalic | 4 | Have |
| | | | | acid/Zinc salt of | | acid ester | | |
| | | | | fatty acid | | | | |
| | Test piece 3 | 54 | 56,000 | Tribasic lead sulfate | 5 | Phthalic | 2 | Have |
| | | | | | | acid ester | | |
| | Test piece 4 | 54 | 64,000 | Calcium salt of fatty | 5 | Not added | — | Have |
| | | | | acid/Zinc salt of | | | | |
| | | | | fatty acid | | | | |
| | Test piece 5 | 61 | 64,000 | Tribasic lead sulfate | 5 | Not added | — | Have |
| Comparative | Test piece 6 | 50 | 48,000 | Calcium salt of fatty | 5 | Phthalic | 6 | Not have |
| example | | | | acid/Zinc salt of | | acid ester | | |
| | | | | fatty acid | | | | |

As shown in the above, it was confirmed that the test pieces composed of vinyl chloride resins having a chlorine content of 51% by mass or more had heat resistance and corrosion resistance for a long period of time even in the liquid electrolyte containing aluminum chloride and having high corrosiveness. The corrosion resistance was evaluated at 80° C., which is higher than an operating temperature (about 40° C. to 60° C.) at which plating is assumed to be conducted.

A molten-salt electrolysis plating apparatus was prepared in which at least portions of components in contact with a liquid electrolyte, the portions being in contact with the liquid electrolyte, for example, piping for circulating a liquid electrolyte and an inner wall surface of a plating tank of the molten-salt electrolysis plating apparatus, were composed of the vinyl chloride resin of test piece 1.

A plating liquid was prepared by adding 1,10-phenanthroline as an additive to a liquid electrolyte obtained by mixing 1-ethyl-3-methylimidazolium chloride and aluminum chloride in a molar ratio of 1:2. The plating tank of the molten-salt electrolysis plating apparatus was filled with the plating liquid. A foamed urethane which had 46 cells/inch and a thickness of 1 mm and which was subjected to a conductivity-imparting treatment was used as a base. An aluminum film was formed on a surface of the base.

The aluminum film formed on the surface of the base had a thickness of 10 and was a homogeneous film with a good quality. The molten-salt electrolysis plating apparatus could be continuously used because the vinyl chloride resin of the portions that were in contact with the liquid electrolyte had heat resistance and corrosion resistance and thus did not change.

### Example 2 and Comparative Example

As shown in Table II, vinyl chloride resins having the respective compositions were prepared, and processed to have a rectangular columnar shape, as described above. Thus, test pieces 1 to 6 were prepared. A liquid in which 1-ethyl-3-methylimidazolium chloride and aluminum chloride were mixed in a molar ratio of 1:2 was prepared as a liquid electrolyte.

Titanium oxide was dispersed in some of the vinyl chloride resins by a melt-kneading method. Specifically, in a state where a vinyl chloride resin was heated to a temperature equal to or higher than a melting point or a softening point thereof, titanium oxide was added while applying a shear stress, thus uniformly dispersing the titanium oxide in the vinyl chloride resin. Titanium oxide having a rutile-type crystal structure was used.

As in the method for evaluating corrosion resistance described above, each of the test pieces was immersed in 5 mL of the liquid electrolyte and stored in a thermostatic chamber at 80° C.

Table II shows the results.

TABLE II

| | | | | | Number- | | | | | |
|---|---|---|---|---|---|---|---|---|---|---|
| | | Titanium oxide | | | average | | | | | Evaluation |
| | | | Particle | Chlorine | molecular | Stabilizing agent | | Plasticizing agent | | Heat resistance/ |
| | | Content | diameter | content | weight | | Content | | Content | Corrosion |
| | | (mass %) | (μm) | (mass %) | (Mn) | Type | (mass %) | Type | (mass %) | resistance |
| Example 2 | Test piece 1 | 0.2 | 2.0 | 61 | 56,000 | Calcium salt of fatty | 5 | Phthalic | 4 | Have |
| | | | | | | acid/Zinc salt of | | acid ester | | |
| | | | | | | fatty acid | | | | |
| | Test piece 2 | 0.8 | 0.4 | 54 | 64,000 | Calcium salt of fatty | 5 | Phthalic | 4 | Have |
| | | | | | | acid/Zinc salt of | | acid ester | | |
| | | | | | | fatty acid | | | | |
| | Test piece 3 | 2.0 | 2.0 | 54 | 56,000 | Tribasic lead sulfate | 5 | Phthalic | 2 | Have |
| | | | | | | | | acid ester | | |
| | Test piece 4 | 0.8 | 0.4 | 54 | 64,000 | Calcium salt of fatty | 5 | Not | — | Have |
| | | | | | | acid/Zinc salt of | | added | | |
| | | | | | | fatty acid | | | | |
| | Test piece 5 | 2.0 | 0.15 | 61 | 64,000 | Tribasic lead sulfate | 5 | Not | — | Have |
| | | | | | | | | added | | |
| Comparative | Test piece 6 | — | — | 50 | 48,000 | Calcium salt of fatty | 5 | Phthalic | 6 | Not have |
| example | | | | | | acid/Zinc salt of | | acid ester | | |
| | | | | | | fatty acid | | | | |

As shown in the above, it was confirmed that the test pieces composed of vinyl chloride resins containing titanium oxide had heat resistance and corrosion resistance for a long period of time even in the liquid electrolyte containing aluminum chloride and having high corrosiveness. The corrosion resistance was evaluated at 80° C., which is higher than an operating temperature (about 40° C. to 60° C.) at which plating is assumed to be conducted.

A molten-salt electrolysis plating apparatus was prepared in which at least portions of components in contact with a liquid electrolyte, the portions being in contact with the liquid electrolyte, for example, piping for circulating a liquid electrolyte and an inner wall surface of a plating tank of the molten-salt electrolysis plating apparatus, were composed of the vinyl chloride resin of test piece 1.

A plating liquid was prepared by adding 1,10-phenanthroline as an additive to a liquid electrolyte obtained by mixing 1-ethyl-3-methylimidazolium chloride and aluminum chloride in a molar ratio of 1:2. The plating tank of the molten-salt electrolysis plating apparatus was filled with the plating liquid. A foamed urethane which had 46 cells/inch and a thickness of 1 mm and which was subjected to a conductivity-imparting treatment was used as a base. An aluminum film was formed on a surface of the base.

The aluminum film formed on the surface of the base had a thickness of 10 μm, and was a homogeneous film with a good quality. The molten-salt electrolysis plating apparatus could be continuously used because the vinyl chloride resin of the portions that were in contact with the liquid electrolyte had heat resistance and corrosion resistance and thus did not change.

Next, a description will be made of a method for evaluating corrosion resistance of a polyethylene resin used in a molten-salt electrolysis plating apparatus of the present invention.

### —Method for Evaluating Corrosion Resistance and Heat Resistance of Polyethylene Resin—

(1) A test piece composed of a polyethylene resin and having a rectangular columnar shape (5×5×10 mm) is prepared.
(2) The test piece is immersed in 5 mL of a liquid electrolyte (plating liquid), and stored in a thermostatic chamber at 80° C.
(3) The state of the test piece is periodically checked.
(4) After three months at the longest, the test piece is taken out, and a surface and a cross section of the test piece are observed.

### <Evaluation Criteria>

In the observation of the surface and the cross section of the test piece in (4) above, only in the case where both the surface and the cross section did not degrade compared with those before the immersion, it was determined that the test piece had corrosion resistance and heat resistance. In the case where degradation such as a trace of corrosion or a crack was observed, it was determined that the test piece did not have corrosion resistance.

A test piece having low corrosion resistance eluted in the liquid electrolyte at the time of (3) above. A test piece having an extremely low corrosion resistance dissolved in the liquid electrolyte completely. With regard to a test piece having somewhat low corrosion resistance, the liquid color of the liquid electrolyte changed from transparent to black due to an eluted component of the resin.

### Example 3 and Comparative Example

As shown in Table III, polyethylene resins having the respective compositions were prepared, and processed to have a rectangular columnar shape, as described above. Thus, test pieces 1 to 6 were prepared. A liquid in which 1-ethyl-3-methylimidazolium chloride and aluminum chloride were mixed in a molar ratio of 1:2 was prepared as a liquid electrolyte.

Titanium oxide was dispersed in some of the polyethylene resins by a melt-kneading method. Specifically, in a state where a polyethylene resin was heated to a temperature equal to or higher than a melting point or a softening point thereof, titanium oxide was added while applying a shear stress, thus uniformly dispersing the titanium oxide in the polyethylene resin. Titanium oxide having a rutile-type crystal structure was used.

As in the method for evaluating corrosion resistance described above, each of the test pieces was immersed in 5 mL of the liquid electrolyte and stored in a thermostatic chamber at 80° C.

Table III shows the results.

TABLE III

| | | Polyethylene resin | | Titanium oxide | | Evaluation |
|---|---|---|---|---|---|---|
| | | | Weight-average | | Particle | Heat resistance/ |
| | | Density | molecular weight | Content | diameter | Corrosion |
| | | (g/cm³) | (Mw) | (mass %) | (μm) | resistance |
| Example 3 | Test piece 1 | 0.943 | 600,000 | 0.2 | 2.0 | Have |
| | Test piece 2 | 0.948 | 900,000 | 0.8 | 0.4 | Have |
| | Test piece 3 | 0.955 | 1,500,000 | 2.0 | 2.0 | Have |
| | Test piece 4 | 0.962 | 3,800,000 | 0.8 | 0.4 | Have |
| | Test piece 5 | 0.968 | 6,000,000 | 2.0 | 0.15 | Have |
| Comparative | Test piece 6 | 0.938 | 50,000 | — | — | Not have |
| example | | | | | | |

As shown in the above, it was confirmed that the test pieces composed of polyethylene resins having a density of 0.940 g/cm³ or more had heat resistance and corrosion resistance for a long period of time even in the liquid electrolyte containing aluminum chloride and having high corrosiveness. The corrosion resistance was evaluated at 80° C., which is higher than an operating temperature (about 40° C. to 60° C.) at which plating is assumed to be conducted.

A molten-salt electrolysis plating apparatus was prepared in which at least portions of components in contact with a liquid electrolyte, the portions being in contact with the liquid electrolyte, for example, piping for circulating a liquid electrolyte and an inner wall surface of a plating tank of the molten-salt electrolysis plating apparatus, were composed of the polyethylene resin of test piece 1.

A plating liquid was prepared by adding 1,10-phenanthroline as an additive to a liquid electrolyte obtained by mixing 1-ethyl-3-methylimidazolium chloride and aluminum chloride in a molar ratio of 1:2. The plating tank of the molten-salt electrolysis plating apparatus was filled with the plating liquid. A foamed urethane which had 46 cells/inch and a thickness of 1 mm and which was subjected to a conductivity-imparting treatment was used as a base. An aluminum film was formed on a surface of the base.

The aluminum film formed on the surface of the base had a thickness of 10 μm and was a homogeneous film with a good quality. The molten-salt electrolysis plating apparatus could be continuously used because the polyethylene resin of the portions that were in contact with the liquid electrolyte had heat resistance and corrosion resistance and thus did not change.

### Example 4 and Comparative Example

As shown in Table IV, polyethylene resins having the respective physical properties were prepared, and processed to have a rectangular columnar shape, as described above. Thus, test pieces 1 to 6 were prepared. A liquid in which 1-ethyl-3-methylimidazolium chloride and aluminum chloride were mixed in a molar ratio of 1:2 was prepared as a liquid electrolyte.

As in the method for evaluating corrosion resistance described above, each of the test pieces was immersed in 5 mL of the liquid electrolyte and stored in a thermostatic chamber at 80° C.

Table IV shows the results.

TABLE IV

| | | Polyethylene resin | | | |
|---|---|---|---|---|---|
| | | Tensile | Number-average | Degree of | Evaluation |
| | | strength | molecular weight | crystallinity | Heat resistance/ |
| | | (MPa) | (Mn) | (%) | Corrosion resistance |
| Example 4 | Test piece 1 | 16 | 600,000 | 52 | Have |
| | Test piece 2 | 18 | 900,000 | 58 | Have |
| | Test piece 3 | 24 | 1,500,000 | 65 | Have |
| | Test piece 4 | 26 | 3,800,000 | 73 | Have |
| | Test piece 5 | 30 | 6,000,000 | 76 | Have |
| Comparative | Test piece 6 | 12 | 50,000 | 40 | Not have |
| example | | | | | |

As shown in the above, it was confirmed that the test pieces composed of polyethylene resins having a tensile strength of 15 MPa or more had heat resistance and corrosion resistance for a long period of time even in the liquid electrolyte containing aluminum chloride and having high corrosiveness. The corrosion resistance was evaluated at 80° C., which is higher than an operating temperature (about 40° C. to 60° C.) at which plating is assumed to be conducted.

A molten-salt electrolysis plating apparatus was prepared in which at least portions of components in contact with a liquid electrolyte, the portions being in contact with the liquid electrolyte, for example, piping for circulating a liquid electrolyte and an inner wall surface of a plating tank of the molten-salt electrolysis plating apparatus, were composed of the polyethylene resin of test piece 1.

A plating liquid was prepared by adding 1,10-phenanthroline as an additive to a liquid electrolyte obtained by mixing 1-ethyl-3-methylimidazolium chloride and aluminum chloride in a molar ratio of 1:2. The plating tank of the molten-salt electrolysis plating apparatus was filled with the plating liquid. A foamed urethane which had 46 cells/inch and a thickness of 1 mm and which was subjected to a conductivity-imparting treatment was used as a base. An aluminum film was formed on a surface of the base.

The aluminum film formed on the surface of the base had a thickness of 10 μm and was a homogeneous film with a good quality. The molten-salt electrolysis plating apparatus could be continuously used because the polyethylene resin of the portions that were in contact with the liquid electrolyte had heat resistance and corrosion resistance and thus did not change.

1. A molten-salt electrolysis plating apparatus that uses a molten salt for a liquid electrolyte,
the molten-salt electrolysis plating apparatus satisfying any one of (i) to (iv) below.
(i) At least a portion of the molten-salt electrolysis plating apparatus, the portion being in contact with the liquid electrolyte, contains a vinyl chloride resin, and
the vinyl chloride resin has a chlorine content of 51% by mass or more.
(ii) At least a portion of the molten-salt electrolysis plating apparatus, the portion being in contact with the liquid electrolyte, contains a vinyl chloride resin, and
the vinyl chloride resin contains titanium oxide.
(iii) At least a portion of the molten-salt electrolysis plating apparatus, the portion being in contact with the liquid electrolyte, contains a polyethylene resin, and
the polyethylene resin has a density of 0.940 g/cm³ or more.
(iv) At least a portion of the molten-salt electrolysis plating apparatus, the portion being in contact with the liquid electrolyte, contains a polyethylene resin, and
the polyethylene resin has a tensile strength of 15 MPa or more.

2. The molten-salt electrolysis plating apparatus according to claim 1, wherein at least a portion of the molten-salt electrolysis plating apparatus, the portion being in contact with the liquid electrolyte, contains a vinyl chloride resin, the vinyl chloride resin has a chlorine content of 51% by mass or more, and
the vinyl chloride resin has a number-average molecular weight of 50,000 or more and 100,000 or less.

3. The molten-salt electrolysis plating apparatus according to claim 1, wherein at least a portion of the molten-salt electrolysis plating apparatus, the portion being in contact with the liquid electrolyte, contains a vinyl chloride resin, the vinyl chloride resin has a chlorine content of 51% by mass or more, and
the vinyl chloride resin contains a stabilizing agent that contains lead.

4. The molten-salt electrolysis plating apparatus according to claim 1, wherein at least a portion of the molten-salt electrolysis plating apparatus, the portion being in contact with the liquid electrolyte, contains a vinyl chloride resin, the vinyl chloride resin contains titanium oxide, and
the vinyl chloride resin has a titanium oxide content of 0.1% by mass or more and 15% by mass or less.

5. The molten-salt electrolysis plating apparatus according to claim 1, wherein at least a portion of the molten-salt electrolysis plating apparatus, the portion being in contact with the liquid electrolyte, contains a vinyl chloride resin, the vinyl chloride resin contains titanium oxide, and
the titanium oxide has a particle diameter of 0.1 μm or more and 100 μm or less.

6. The molten-salt electrolysis plating apparatus according to claim 1, wherein at least a portion of the molten-salt electrolysis plating apparatus, the portion being in contact with the liquid electrolyte, contains a polyethylene resin, the polyethylene resin has a density of 0.940 g/cm³ or more, and
the polyethylene resin has a weight-average molecular weight of 500,000 or more and 6,500,000 or less.

7. The molten-salt electrolysis plating apparatus according to claim 1, wherein at least a portion of the molten-salt electrolysis plating apparatus, the portion being in contact with the liquid electrolyte, contains a polyethylene resin, the polyethylene resin has a density of 0.940 g/cm³ or more, and
the polyethylene resin contains titanium oxide.

8. The molten-salt electrolysis plating apparatus according to claim 1, wherein at least a portion of the molten-salt electrolysis plating apparatus, the portion being in contact with the liquid electrolyte, contains a polyethylene resin, the polyethylene resin has a tensile strength of 15 MPa or more, and
the polyethylene resin has a weight-average molecular weight of 500,000 or more and 6,500,000 or less.

9. The molten-salt electrolysis plating apparatus according to claim 1, wherein at least a portion of the molten-salt electrolysis plating apparatus, the portion being in contact with the liquid electrolyte, contains a polyethylene resin, the polyethylene resin has a tensile strength of 15 MPa or more, and
the polyethylene resin has a degree of crystallinity of 50% or more and 80% or less.

10. The molten-salt electrolysis plating apparatus according to claim 1, wherein the molten salt contains aluminum chloride and has a melting point of 80° C. or less.

11. A method for producing an aluminum film, comprising electrodepositing aluminum on a base by using the molten-salt electrolysis plating apparatus according to claim 1.
